(19) United States
(12) Patent Application Publication
(10) Pub. No.: US 2026/0212027 A1
(43) Pub. Date: Jul. 23, 2026

(54) SYSTEM AND METHODS FOR DETECTING CODE SECURITY VULNERABLILITY USING TOKEN-BASED IDENTIFICATION AND ROOT CAUSE ANALYSIS

(71) Applicant: Board of Regents, The University of Texas System, Austin, TX (US)

(72) Inventors: Nafis Islam, San Antonio, TX (US); Peyman Najafirad, San Antonio, TX (US)

(21) Appl. No.: 19/457,348

(22) Filed: Jan. 23, 2026

Related U.S. Application Data
(60) Provisional application No. 63/748,485, filed on Jan. 23, 2025.

(51) Int. Cl. G06F 21/57

(52) U.S. Cl. CPC G06F 21/577; G06F 2221/033

(57) ABSTRACT

The system and method include the steps of tokenizing the software code written in a programming language to generate an ordered sequence of tokens, generating a vector embedding for each token in the ordered sequence, serializing the vector embeddings to preserve positional correspondence between each token and a respective vector embedding, constructing a graph-based representation of the software code by assigning each serialized vector embedding as an initial feature of a corresponding node in a graph, feeding the graph-based representation token embeddings to an ensemble machine learning model comprising a plurality of models to determine token-level attribution scores that represent contributions of each token, and generating a vulnerability prediction output associated with the software code, based on the graph-based representation and the token-level attribution scores, the vulnerability prediction output providing a classification and localization of the vulnerability to identify a root cause of the vulnerability.

### RELATED APPLICATION

This application claims the benefit of U.S. Provisional Application No. 63/748,485 filed on Jan. 23, 2025, the entirety of which is incorporated herein by reference.

### FIELD OF INNOVATION

This relates to the field of software security, and in particular, embodiments of the present disclosure related to system and methods of precise code repairs and contextual root cause analysis of vulnerability.

### BACKGROUND

Open-source software (OSS) has become a cornerstone of modern technology, powering systems from IoT platforms to critical software supply chains. However, this widespread adoption has also made OSS a prime target for cyber adversaries. Past security breaches affecting large numbers of end users, including government bodies and critical infrastructure providers, underscore the severe consequences of software vulnerabilities. These incidents highlight the critical nature of software security, particularly in widely-used libraries, where vulnerabilities can lead to extensive service disruptions.

Traditional approaches often grapple with the challenge of accurately identifying vulnerabilities in the software code. While conventional tools like Cppcheck, FlawFinder, RATS, and Infer provide direct approaches to vulnerability localization, their high false positive and false negative rates underscore the need for more reliable methods. Identifying the root cause of vulnerabilities within a system is a formidable task, especially given the disconnect between states where code crashes and actual root causes.

### BRIEF DESCRIPTION OF THE DRAWINGS

Embodiments will be described, by way of example only, with reference to the attached drawing figures:

FIG. 1 is a simplified flow diagram of a vulnerability analysis system configured for identifying, repairing, and providing proper vulnerability description message. The system utilizes an ensemble Large Language Model (LLM) token-based localization technique and explainability.

FIG. 2 shows an example of the input code and the outcome generated by the system.

FIG. 3 shows the high-level architecture of the system and method.

FIG. 4 is a flow diagram showing our proposed algorithm for finding the root cause of vulnerability with explainability.

### SUMMARY

The resent invention provides an end-to-end system to analyze vulnerabilities in IoT device operating systems. A method for classifying and identifying code vulnerability attacks on a computing device, comprise: extracting code data from a database; converting the code data into tokens for processing; generating a token embedding of the tokens via serialized token embedding and scalable vector graphic (SVG) embedding, assigning each feature to an embedded space; feeding the token embeddings into an ensemble model to determine classification and localization of a vulnerability, where the ensemble model comprises a transformer and a graph convolutional network (GCN) model; calculating the contribution each token has towards the classification and localization of the vulnerability to identify a root cause of the vulnerability. This method further comprises: processing the code data with a large language model (LLM) encoder neural network to generate an embedding of the code data, wherein the LLM encoder neural network is configured by training the encoder neural network with a decoder neural network, the decoder neural network including an input for receiving the embedding of the code data, the decoder neural network generating an output that includes at least a category associated with the code data. The present invention also includes a system for classifying and identifying code vulnerability attacks on a computing device. The system comprises a processor and a non-transitory computer-readable storage medium storing instructions that, when executed by the processor, cause the processor to perform the above method for classifying and identifying code vulnerability attacks.

### DETAILED DESCRIPTION OF FIGURES

Embodiments of methods, systems, and apparatus are described through reference to the drawings.

The following discussion provides example embodiments of the inventive subject matter. Although each embodiment may represent a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

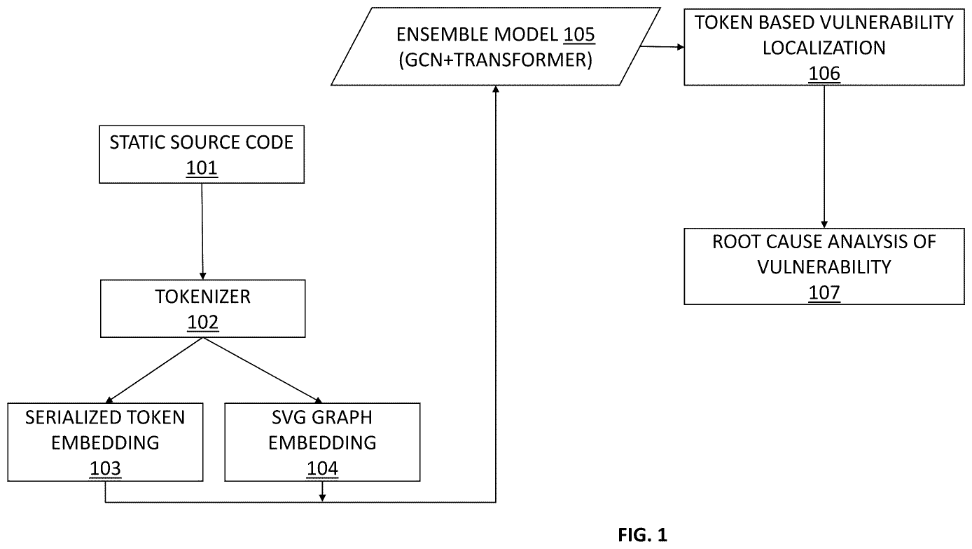

FIG. 1 is a simplified flow diagram of a vulnerability analysis system that is an end-to-end system for analyzing vulnerabilities in IoT device operating systems. The system can be decomposed into several components to clearly define and formalize the functionality of each step in vulnerability analysis. In the vulnerability analysis framework, a Repository Scanner first extracts static source code 101. The Repository Scanner employs the open-source code analysis platform Joern for code extraction at a function level from IoT operating systems' source code. The primary functionality of Joern includes scanning C/C++ files to generate a Code Property Graph (CPG). This CPG is a graphical representation capturing the fundamental aspects of the source code. The CPG is stored within an in-memory graph database, OverflowDB. The CPG facilitates the execution of intricate search operations within the source code via Scala-based queries. This capability enables the retrieval of significant data, such as extracting all functions from the repository and pertinent metadata. These include the total count of scanned files, the number of C/C++ codes, function definitions, internal and external function calls, and commits, providing us with a comprehensive code overview.

The construction of queries to extract this data begins with traversing the CPG, with the root object “CPG” representing the CPG under analysis. The node type “METHOD” is selected for traversal, signifying all function or procedure declarations within the repository. The number of function definitions is ascertained by invoking the size property of the corresponding “METHOD” node. A similar approach is used for calculating the total count of internal and external function calls, incorporating the use of a Filter Step that leverages the “ISEXTERNAL” property. This aids in filtering relevant nodes for a more precise extraction process. To extract all functions from the repository, the corresponding “METHOD” nodes are called upon, utilizing a specific Joern feature that allows function extraction in the preferred JSON format. This meticulous process ensures that the extracted functions are primed for subsequent vulnerability analysis using the VulDetector and VulExplainer components of the present system.

Tokenization plays a crucial role in analyzing code in vulnerability detection. By breaking code into tokens, security tools can identify patterns and anomalies that might indicate potential vulnerabilities. In the present approach, the input consists of an entire function, which may be vulnerable or non-vulnerable. After extracting the static source code 101, a tokenizer 102 is utilized to generate the tokens from the extracted code. In one embodiment, a CodeT5 tokenizer is initially employed. The CodeT5 tokenizer is pretrained in programming languages like C/C++, to extract the tokens T from a given function pᵢ.

During the tokenization process, programming language operators and keywords are preserved as atomic units rather than being arbitrarily segmented. This design choice is critical for maintaining the semantic integrity of source code. Unlike natural language, where subword tokenization is often acceptable, program semantics depend heavily on exact keyword and operator forms. For example, keywords written in camelCasing or snake_casing styles are retained as single tokens to represent the entire keyword accurately. To achieve this, we validate whether a token is split into multiple tokens, and if so, the first token is always considered during the tokenization process. This approach guarantees that the complete keyword is treated as a single word.

Since the CodeT5 tokenizer is limited to 512 tokens as the longest input size, the length of T is trimmed to this length. Moreover, two special tokens, <BOS> and <EOS>, are introduced at the beginning and end of a program. If the length of the program is less than 512, a special token <PAD> is employed to resize the length to 512.

Once tokenization is complete, each token is transformed into a dense numerical representation, referred to as an embedding. Embedding is a foundational technique in machine learning that converts discrete symbols—such as text or code tokens—into continuous-valued vectors. These vectors capture both syntactic structure and semantic relationships, enabling models to reason about similarity, context, and functionality.

For each token in the serialized token sequence, an embedding E is generated, resulting in a serialized token embedding representation (103). These embeddings encode contextual information learned during pre-training and serve as the primary feature representation for subsequent analysis. Each embedding for a token is considered as a node G within a graph-based representation. Using an SVG-based graph embedding technique (104), token embeddings are structured into a graph that captures relationships among tokens, such as adjacency, control flow relevance, and semantic proximity. This graph formulation allows the system to move beyond linear token sequences and model richer structural dependencies inherent in source code.

The embedding generation relies on CodeT5, a transformer-based model pre-trained on large-scale programming language corpora with an emphasis on code understanding and security analysis. Because CodeT5 has already learned meaningful representations of programming constructs, its embeddings provide a strong initial representation of tokens without requiring training from scratch. These pre-trained CodeT5 embeddings are therefore leveraged as the initial token representations, forming the foundation for subsequent graph-based learning, analysis, or security-focused inference tasks.

Multitask VulCodeT5: The encoder component of VulCodeT5 consists of multiple layers of self-attention and feed-forward neural networks. The self-attention mechanism computes attention weights to capture the input sequence's interdependencies and relationships between elements. This allows for the encoding of contextual information. The output from the self-attention layer is then passed through a feed-forward neural network, which applies a nonlinear transformation independently at each position.

The task of hunting program vulnerabilities poses significant challenges, especially when it comes to classifying and localizing vulnerabilities across different IoT repositories. The diverse coding patterns programmers employ contribute to this challenge, even when they result in similar bugs. For instance, a vulnerability may arise simply due to the absence of a NULL check statement. These memory-related vulnerabilities can be effectively captured using graph-based networks. On the other hand, particular vulnerabilities arising from incorrect library function calls or pointer usage may be more amenable to resolution using transformer-based techniques since they can capture the complex relationships and dependencies within code more effectively. In the first case, a GCN model could easily capture the lack of NULL check. However, in the second case, the vulnerability occurs as a plain function call, which is difficult to be captured by a GCN but much easier to be captured by a transformer-based model because of its capability to capture the token-related dependencies using attention. Therefore, training the model only on one of the models is challenging since we risk the possibility of missing some vulnerabilities. Hence a more effective way to capture vulnerability is to use an ensemble model.

As shown in FIG. 1, after the SVG graph embedding 104, an ensemble model 105 combining Graph Convolutional Network (GCN) and Transformer Ensemble Model is employed. The encoder is employed and combined with GCN for the ensemble multitask model. Since an encoder-decoder architecture is employed to generate vulnerability descriptions, the decoder layer is frozen so that the weights of the decoder remain unchanged during the training of the ensemble model. The Graph Convolution Network (GCN) is specifically designed to capture the correlations between two nodes in a graph. To capture the relationships between two tokens of a program, the GCN uses SVG, combining data flow, control flow, sequential flow, and poacher flow. A two-layered GCN architecture is constructed with a residual connection to enhance the model's expressive power and facilitate information flow across layers. The feature vector generated by the GCN is denoted as F_{GCN}, encapsulating the learned representations and capturing the relevant features of the program tokens.

After establishing the ensemble model 105, a token-based vulnerability localization 106 is conducted. Token-based vulnerability localization 106 identifies one or more root-cause tokens associated with a security vulnerability by generating token-level attribution scores and mapping the attribution scores to corresponding locations in the program. The ensemble model 105 is employed to detect the common weakness enumeration (CWE) number of a vulnerability and the token range of the code where the vulnerability exists. CWE numbers are used to categorize vulnerabilities based on their underlying root causes, track the prevalence of different types of vulnerabilities over time, and assess the potential risk of vulnerabilities. The token range is crucial for precise vulnerability location. Thus, for vulnerability classification and localization purposes, the outcome of the encoder layer and the embedding of GCN is obtained. Both have an equal embedding size of size 512.

Two dense layers are added in parallel. The first dense layer generates the CWE Number of the vulnerable code. If no vulnerability exists, the model generates an output of 0. The second dense layer generates Lᵥᵤₗₙ, which is the token range where the vulnerability exists. With the capability of multi-head self-attention in transformer, the final representations produced by the model have a global perspective on the entire function. Assuming that the feature vector represented by a transformer is F_{R} and the final feature vector F_{E} is the average summation of VulCodeT5 and GCN we represent in the following Equation:

$${F}_{E} = {F}_{R} + {F}_{GCN}$$

Where F_{E} is connected with two dense layers, one for vulnerability classification and another for finding the vulnerable line.

The Focal Loss function, built on top of CrossEntropyLoss, can handle possible data imbalance issues. The Focal Loss function stands thus:

$$FocalLoss ( {p}_{rob}^{t} ) = - {α ( 1 - {p}_{rob}^{t} )}^{δ} log ( {p}_{rob}^{t} )$$

In this instance, a denotes the balancing factor between the number of vulnerable and non-vulnerable code samples, while

$${p}_{rob}^{t}$$

is the probability distribution of our model's output. The method uses δ as an adjustable parameter that distinguishes between easy and hard examples. Furthermore, we apply MSE loss for vulnerability localization. Our MSE loss function is defined as follows:

$$MSE = \frac{1}{n} \sum {( L - \hat{L} )}^{2}$$

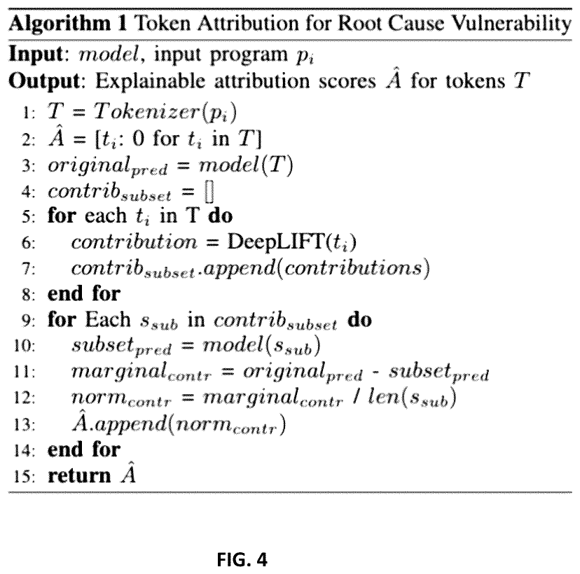

After conducting token-based vulnerability localization 106, a root cause of vulnerability analysis 107 is conducted. Along with providing a vulnerability description, DeepLiftSHAP attribution scores are employed to find the contribution each token has towards the model's classification and localization. DeefLiftSHAP is an explainability technique for neural networks based on executing a SHAPly variant of the original DeepLift algorithm. Combining DeepLIFT and SHAPly, DeepLiftSHAP is operated on deep learning frameworks to enhance explainability to neural network models. The attribution scores of each token in a line is summed to generate an attribution score for each line. Here, Â is the set of explainability scores for all tokens in T of a function pᵢ, where, Â∈{a₁, a₂, . . . , aₘ}. After generating scores for each line or statement, we follow an Algorithm to find the root cause of vulnerability. In one embodiment, we use the algorithm shown in FIG. 4.

$L_{vuln} [T_{Start}, T_{End}] $ is the localized token vulnerability pair the highest attribution scores that are considered as the root cause of the vulnerability, where R_{BERT} is the expected BERTScore.

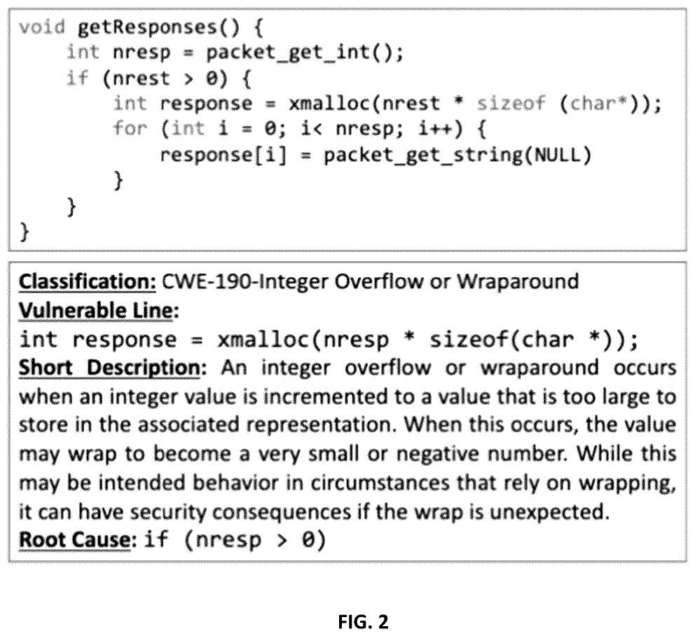

FIG. 2 shows an example of the software code to be analyzed and the outcome generated by the system and method described herein. The system and method categorize the vulnerability, identifies the line of code that gives rise to vulnerability, give a short description of the vulnerability, and identify the root cause of the vulnerability. In this example, the vulnerability is an integer overflow or wraparound error.

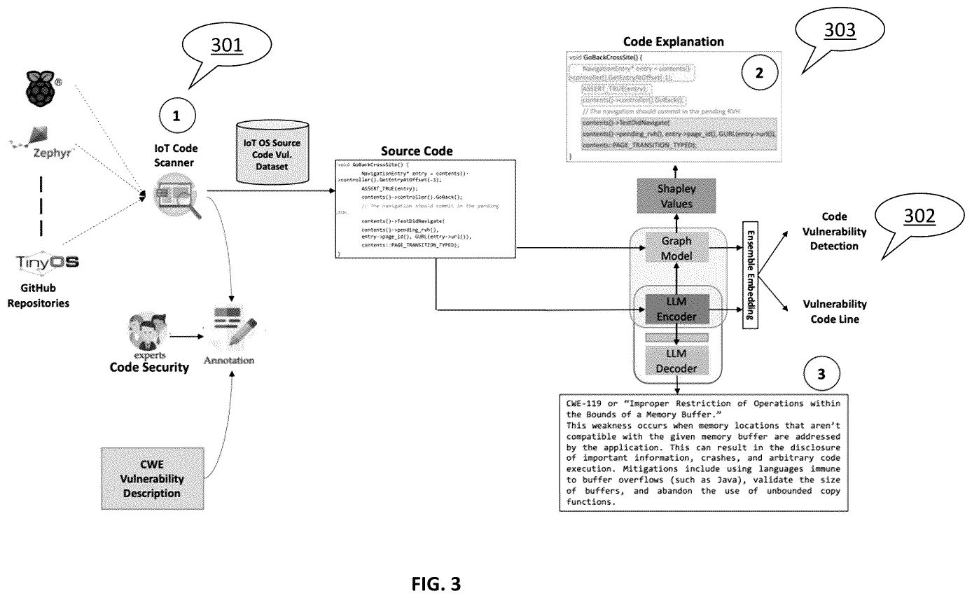

FIG. 3 shows the overall architecture and process flow of the present system. In step 301, the IoT Code Scanner is used to scan and identify the relevant source code, which can be from various open-source repositories, such as GitHub Repositories, Zephyr, etc. In step 302, once code snippets are extracted, the code snippets are broken down into individual tokens. These tokens are then embedded into a format suitable for analysis by large language learning models (LLMs) or machine learning models. Then, a combination of GCN and transformer ensemble model leverages the strengths of multiple models to generate feature vectors of texts and graphs which are analyzed. The ensemble model is employed to detect the common weakness enumeration (CWE) number of a vulnerability and the token range of the code where the vulnerability exists. In step 303, an explainability method is employed to find the root cause of the vulnerability.

FIG. 4 is an example algorithm for the explainability method for the proposed system to find the root cause of the vulnerability. In some embodiments, a computer-implemented method is provided for generating explainable attribution scores corresponding to tokens of a program to identify root causes of security vulnerabilities. The technique operates on a program input and a trained machine learning model and produces token-level attribution values indicative of each token's contribution to a vulnerability prediction. The algorithm computes explainable attribution scores for each token in a program, indicating how much each token contributes to a model's vulnerability prediction. In an embodiment, a program is first received as input and processed by a tokenizer to generate a sequence of tokens. The tokenizer is configured to preserve programming language semantics, including operators and keywords, such that each token corresponds to a meaningful syntactic or semantic unit of the program. The resulting token sequence is denoted as a set of tokens. The trained machine learning model is then applied to the full token sequence to generate an original prediction. The original prediction represents a baseline vulnerability assessment for the program and may correspond to a probability, confidence score, or classification output indicating whether the program exhibits a security vulnerability. For each token in the token sequence, a contribution analysis is performed using an explainability technique. In one embodiment, the explainability technique comprises a Deep Learning Important FeaTures (DeepLIFT) operation applied to the token. In order to normalize the contribution values across token subsets of varying sizes, the marginal contribution value is divided by a cardinality of the corresponding subset. The resulting normalized contribution value represents an attribution score for the token and reflects the token's relative influence on the vulnerability prediction. The normalized attribution score is then associated with the corresponding token in the attribution data structure. This process is repeated for each token in the token sequence until attribution scores have been generated for all tokens. The attribution data structure provides a token-level explanation of the vulnerability prediction generated by the trained model and enables identification of one or more tokens that constitute root causes or significant contributors to the predicted vulnerability.

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A computer-implemented method for technological improvement by classifying and identifying security vulnerability in software code, comprising:
tokenizing the software code written in a programming language to generate an ordered sequence of tokens;
generating a vector embedding for each token in the ordered sequence;
serializing the vector embeddings to preserve positional correspondence between each token and a respective vector embedding;
constructing a graph-based representation of the software code by assigning each serialized vector embedding as an initial feature of a corresponding node in a graph;
feeding the graph-based representation token embeddings to an ensemble machine learning model comprising a plurality of models to determine token-level attribution scores that represent contributions of each token; and
generating a vulnerability prediction output associated with the software code, based on the graph-based representation and the token-level attribution scores, the vulnerability prediction output providing a classification and localization of the vulnerability to identify a root cause of the vulnerability.

2. The computer-implemented method of claim 1, wherein generating the vector embedding for each token comprises generating embeddings that are influenced by surrounding tokens in the ordered sequence through a contextual attention mechanism.

3. The computer-implemented method of claim 1, wherein generating the vulnerability prediction output comprises aggregating outputs of the plurality of models in the ensemble machine learning model.

4. The computer-implemented method of claim 1, wherein determining the token-level attribution scores comprises evaluating an influence of each token on an output of the ensemble machine learning model.

5. The computer-implemented method of claim 4, wherein evaluating the influence of each token comprises applying an explainability operation to the ensemble machine learning model.

6. The computer-implemented method of claim 1, further comprising identifying one or more root-cause tokens associated with a vulnerability based on the token-level attribution scores.

7. The computer-implemented method of claim 1, further comprising accessing an IoT software program stored in a database for evaluation.

8. A non-transitory computer-readable memory having encoded thereon a method that, when executed by a processor, cause the system to technologically improve a software program by classifying and identifying security vulnerability in the software code of the program, the execution of the method causing the processor to:
tokenize the software code written in a programming language to generate an ordered sequence of tokens;
generate, using a pre-trained code representation model, a vector embedding for each token in the ordered sequence of tokens, wherein each vector embedding is a context-aware numerical representation learned about the programming language that reflects semantic relationships between the token and surrounding tokens in the ordered sequence;
serialize the vector embeddings to preserve positional correspondence between each token and a respective vector embedding;
construct a graph-based representation of the software code by assigning each serialized vector embedding as an initial feature of a corresponding node in a graph;
feed the graph-based representation token embeddings to an ensemble machine learning model comprising a plurality of models to determine token-level attribution scores that represent contributions of each token; and
generate a vulnerability prediction output associated with the software code, based on the graph-based representation and the token-level attribution scores, the vulnerability prediction output providing a classification and localization of the vulnerability to identify a root cause of the vulnerability.

9. The non-transitory computer-readable memory of claim 8, wherein the processor generating the vector embedding for each token further comprises generating embeddings that are influenced by surrounding tokens in the ordered sequence through a contextual attention mechanism.

10. The non-transitory computer-readable memory of claim 8, wherein the processor further generating the vulnerability prediction output comprises aggregating outputs of the plurality of models in the ensemble machine learning model.

11. The non-transitory computer-readable memory of claim 8, wherein the processor determining the token-level attribution scores comprises evaluating an influence of each token on an output of the ensemble machine learning model.

12. The non-transitory computer-readable memory of claim 11, wherein the processor evaluating the influence of each token comprises applying an explainability operation to the ensemble machine learning model.

13. The non-transitory computer-readable memory of claim 8, further comprising the processor identifying one or more root-cause tokens associated with a vulnerability based on the token-level attribution scores.

14. The non-transitory computer-readable memory of claim 8, further comprising the processor accessing an IoT software program stored in a database for evaluation.

15. A computer-implemented system for technological improvement by classifying and identifying security vulnerability in software code, comprising:
a processor;
a non-transitory computer-readable storage medium storing instructions that, when executed by the processor, cause the processor to perform a method for classifying and identifying code vulnerable to attacks, the method comprising:
extracting code data from a database;
converting the code data into tokens for processing;
generating a token embedding of the tokens via serialized token embedding and scalable vector graphic (SVG) embedding, assigning each feature to an embedded space;
feeding the token embeddings into an ensemble model to determine classification and localization of a vulnerability, where the ensemble model comprises a transformer and a graph convolutional network (GCN) model; and
calculating the contribution each token has towards the classification and localization of the vulnerability to identify a root cause of the vulnerability.
